(19) United States
(12) Patent Application Publication
(10) Pub. No.: US 2009/0302080 A1
(43) Pub. Date: Dec. 10, 2009

(54) Carry unit for tool box

(76) Inventor: Yi-Ting Lin, Ta-Li City (TW)

Correspondence Address: PHILLIP LIU, 6980, WHITEOAK DRIVE, RICHMOND, BC, V7E 4Z9, CA

(21) Appl. No.: 12/155,477

(22) Filed: Jun. 5, 2008

(51) Int. Cl. B25H 3/00; B65D 85/00; A45F 5/00; A45F 3/02; B25H 3/02; A45F 3/00; A45F 3/04

(52) U.S. Cl. 224/605; 206/373

(57) ABSTRACT

A tool box includes a base and a cover which is pivotably connected with the base. The base and the cover each have recesses defined therein for receiving tools. A carry unit is connected to the tool box via a securing unit connected between the carry unit and the tool box. The tool box can be carried on user's back.

### FIELD OF THE INVENTION

The present invention relates to a carry unit for tool box and the carry unit can be easily connected with or disengaged from the tool box.

### BACKGROUND OF THE INVENTION

A conventional tool box generally includes a base and a cover which has one side pivotably connected with the base. The base and/or the cover each have recesses defined in an inside thereof so as to receive tools therein. The cover may have a locking unit such that the cover can be securely connected with the base when carrying the tool box. Usually, a handle is connected to the base or the cover of the tool box and the user can carry the tool box by grabbing the handle.

However, the tool box requires the user to carry it with one hand and this limits convenience of the user and only one hand can be used when carrying the conventional tool box.

Some manufacturers develop a pull handle extending from the tool box such that the user can pull the tool box by pulling the pull handle. Nevertheless, the existence of the pull handle increases the cost of fabrication and the pull handle cannot be separated from the tool box and occupies extra space. Furthermore, if the ground surface is not even, it is difficult to pull the tool box by using the pull handle.

The present invention intends to provide a carry unit for a tool box and the carry unit includes at least one strap or belt such that the user can carry the tool box on his or her back and two hands of the user can do something else when necessary.

### SUMMARY OF THE INVENTION

The present invention relates to a tool box which includes a base and a cover which is pivotably connected with the base. The base and the cover each have recesses defined therein for receiving tools. A carry unit is connected to the tool box via a securing unit connected between the carry unit and the tool box. The tool box is carried on user's back.

The primary object of the present invention is to provide a carry unit connected to the tool box by a securing unit, the carry unit allows the user to carry the tool box on his or her back and the two hands of the users do not need to carry the tool box.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the carry unit of a tool box of the present invention;

FIG. 2 is a back plane view to show the carry unit of the present invention;

FIG. 2A is a cross sectional view to show the connection of the male and female parts of the carry unit of the present invention;

FIG. 3 is a side plane view to show the carry unit of the present invention;

FIG. 3A is a cross sectional view to show connection strap connected between two sets of the male and female parts of the carry unit of the present invention;

FIG. 4 is an exploded view to show a second embodiment of the carry unit of the present invention, and FIG. 5 is an exploded view to show a third embodiment of the carry unit of the present invention.

### DETAILED DESCRIPTION OF THE PREFERRED EMBODIMENT

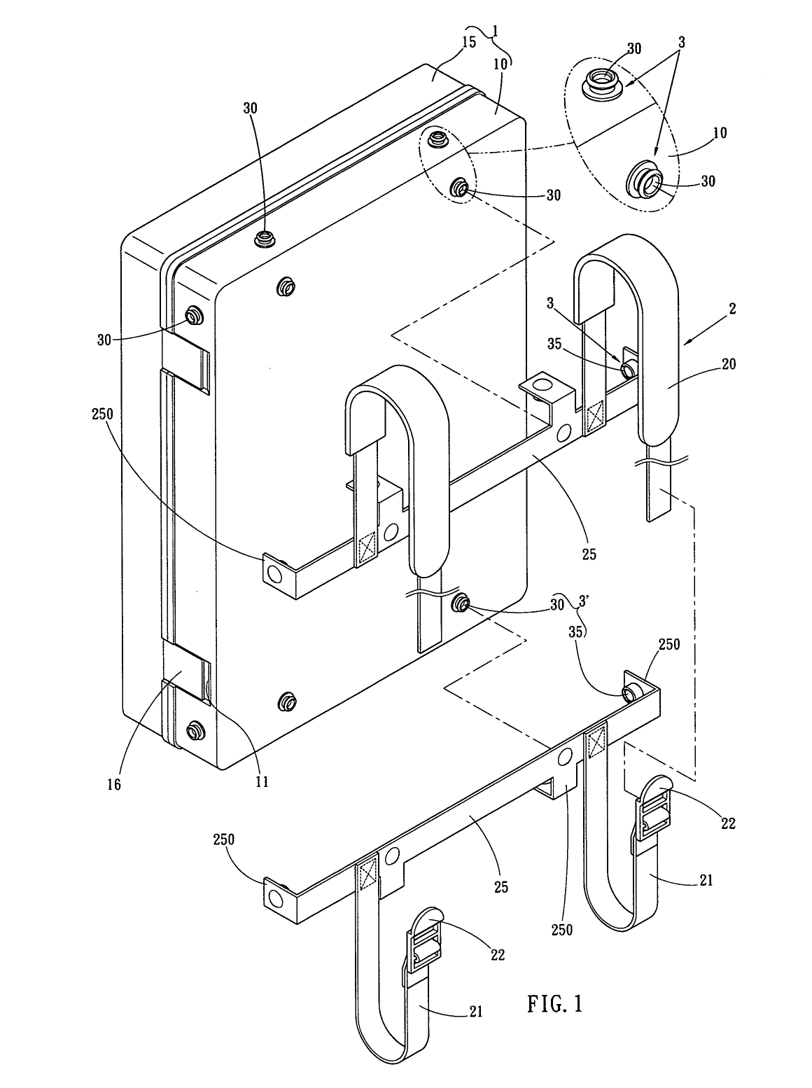

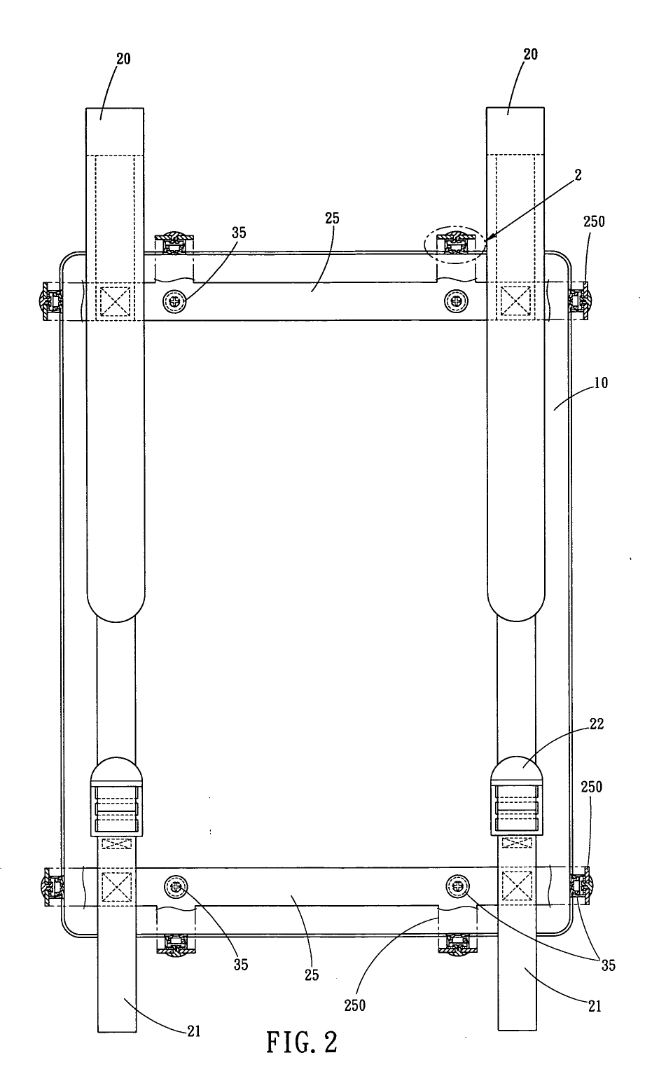

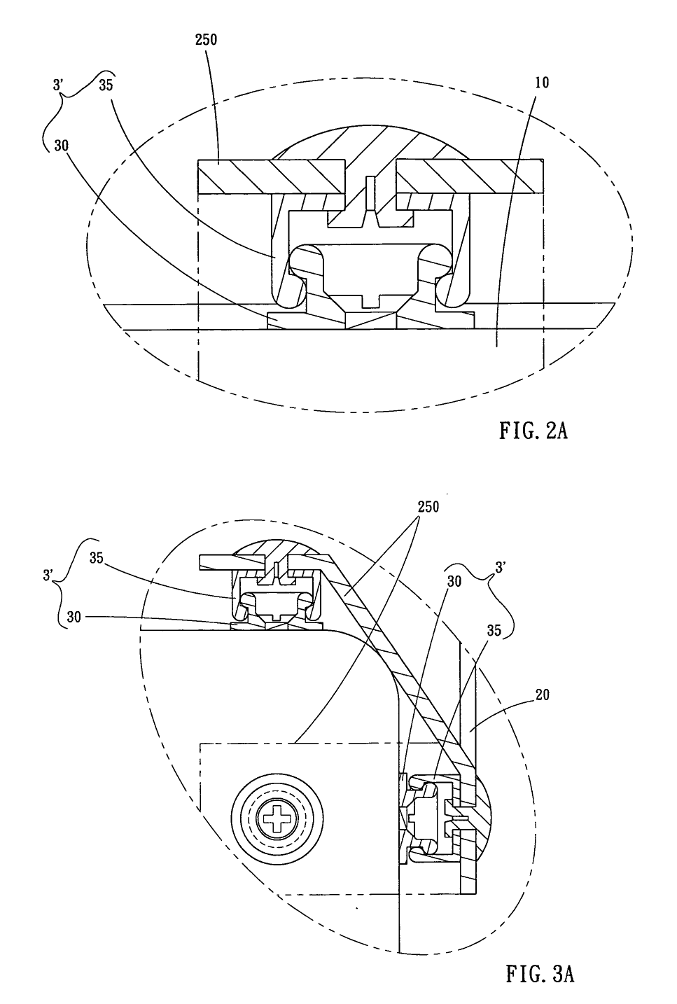

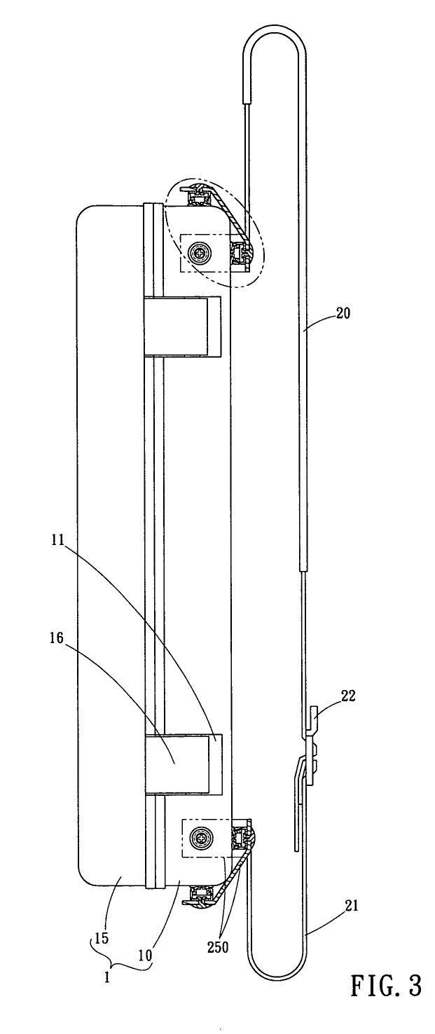

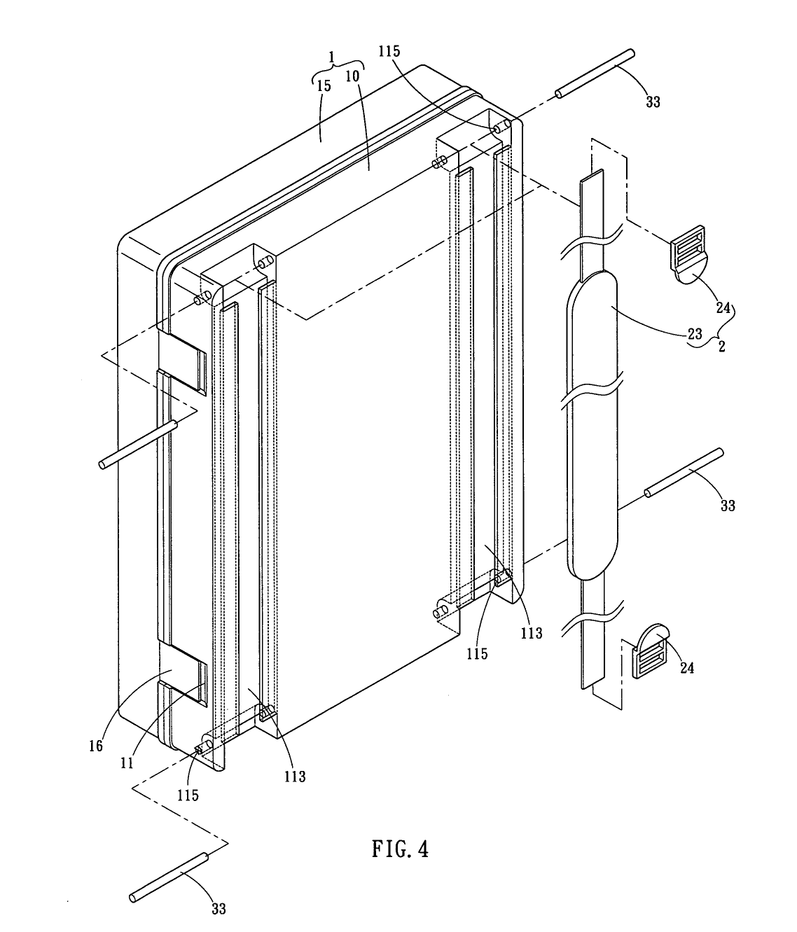

Referring to FIGS. 1, 2, 2A, 3 and 3A, the tool box 1 for cooperation with the carry unit 2 of the present invention includes a base 10 and a cover 15 which is pivotably connected with the base 10. The base 10 and the cover 15 each have recesses (not shown) defined therein so as to receive tools (not shown) in the recesses. The base 10 includes two recessed areas 11 defined in outside thereof and the cover 15 includes two locking members 16 which are able to be locked in the recessed areas 11.

The carry unit 2 of the present invention is connected to the tool box 1 via a securing unit 3 connected between the carry unit 2 and the tool box 1. The securing unit 3 includes multiple connection combinations 3′ and each connection combination 3′ includes a male part 30 and a female part 35 which is removably connected with the male part 30. The male parts 30 are connected to outside of the tool box 1 and the female parts 35 are connected to the carry unit 2. Of course, the female parts 35 can be connected to outside of the tool box 1 and the male parts 30 are connected to the carry unit 2.

The carry unit 2 includes a first set and a second set, wherein the first set includes two shoulder straps 20 and a connection strap 25 is transversely connected between the two shoulder straps 20. The connection strap 25 includes multiple extension portions 250 extending perpendicularly therefrom and female parts 35 are connected to the connection strap 25 and the extension portions 250. The second set includes two adjustment straps 21 and a connection strap 25 is transversely connected between the two adjustment straps 21. The connection strap 25 includes multiple extension portions 250 extending perpendicularly therefrom and female parts 35 are connected to the connection strap 25 and the extension portions 250. The two transverse straps 25 and the extension portions 250 are connected to the tool box 1 by connecting the female parts 35 to the male parts 30. The two adjustment straps 21 are connected with two buckles 22 to which the two shoulder straps 20 are connected. The length of the combination of the shoulder straps 20 and the adjustment straps 21 can be adjusted by using the buckles 22.

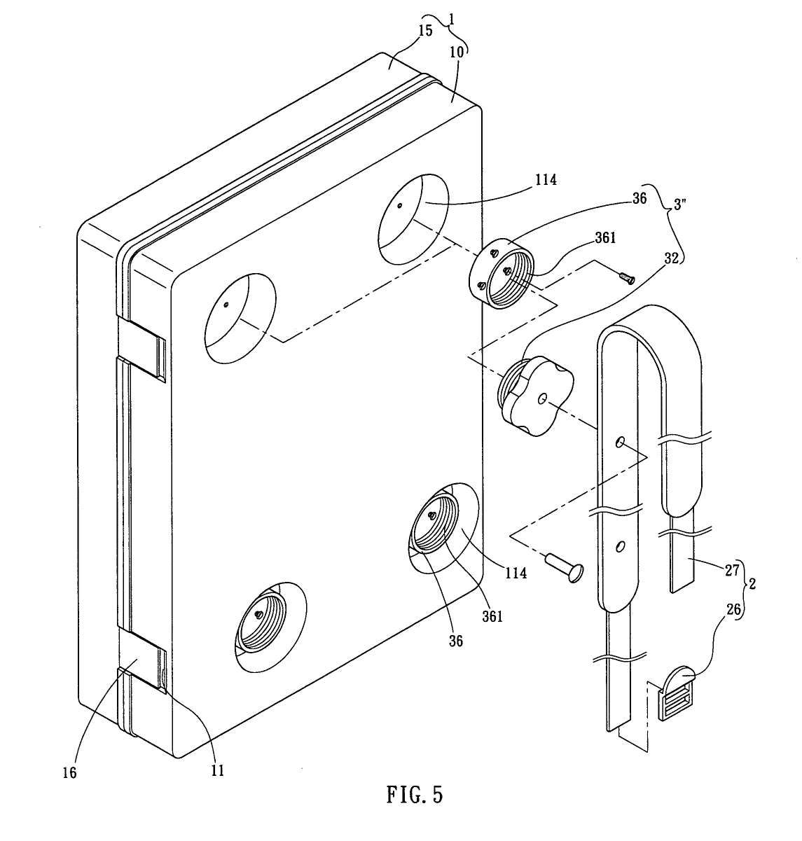

FIG. 4 shows a second embodiment of the carry unit 2 of the present invention, wherein the base 10 of the tool box 1 includes two elongate slots 113 defined in the back thereof and two recesses 115 are defined in two insides of two ends of each of the slots 113. Two pins 33 are respectively engaged with the two recesses 115 at two ends of each of the slots 113. Two ends of the carry unit 2 go around the two pins 33 and are connected to each other. One of the two ends of the carry unit 2 is connected with a buckle 24 and the other end of the shoulder strap 23 is connected to the buckle 24. The number of the shoulder strap 23 can be one or two.

FIG. 5 shows a third embodiment of the carry unit 2 and the securing unit 3 of the present invention, wherein the securing unit 3 includes two second connection combinations 3″ and each second connection combination 3″ includes a second male part 32 and a second female part 36. The second female part 36 includes inner threads 361 and the second male part 32 includes outer threads 321 which are engaged with the inner threads 361. Each of the second female parts 36 is received in a recess 114 defined in the outside of the too box 1 and the second male parts 32 are connected to the carry unit 2. The second female parts 36 are connected to the tool box 1 by bolts. Of course, the second male parts 32 can be received in the recesses 114 defined in the outside of the too box 1 and the second female parts 36 are connected to the carry unit 2. One end of the shoulder strap 27 is connected with a buckle 26 and the other end of the shoulder strap 27 is connected with the buckle 26. The number of the shoulder strap 27 can be one or two.

It is noted that the carry unit 2 can also be fixed to the tool box 1 simply by using screws (not shown) or any known methods. The carry unit 2 can be quickly connected to the tool box 1 or separated from the tool box 1. The two hands of the user are free when carrying the tool box 1 by the carry unit 2 of the present invention.

While we have shown and described the embodiment in accordance with the present invention, it should be clear to those skilled in the art that further embodiments may be made without departing from the scope of the present invention.

What is claimed is:

1. A tool box (1) comprising:
a base (10) and a cover (15) which is pivotably connected with the base (10);
a carry unit (2) connected to the tool box (1) via a securing unit (3) connected between the carry unit (2) and the tool box (1).

2. The too box as claimed in claim 1, wherein the securing unit (3) includes multiple connection combinations (3′) and each connection combination (3′) includes a male part (30) and a female part (35) which is removably connected with the male part (30).

3. The tool box as claimed in claim 2, wherein the male parts (30) are connected to outside of the tool box (1) and the female parts (35) are connected to the carry unit (2).

4. The too box as claimed in claim 1, wherein the securing unit (3) includes two pins (33) and each pin (33) is engaged with two recesses (115) defined in the tool box (1), two ends of the carry unit (2) go around the two pins (33) and are connected to each other.

5. The tool box as claimed in claim 4, wherein one of the two ends of the carry unit (2) is connected with a buckle (24).

6. The tool box as claimed in claim 5, wherein the carry unit (2) is a single shoulder strap (23/27), a combination of a shoulder strap (20) and an adjustment strap (21), a combination of a shoulder strap (20), an adjustment strap (21) and a buckle (22), or a combination of a shoulder strap (20), an adjustment strap (21), a buckle (22) and a connection strap (25).

7. The tool box as claimed in claim 1, wherein the securing unit (3) includes multiple second connection combinations (3″) and each second connection combination (3″) includes a second male part (32) and a second female part (36), the second female part (36) includes inner threads (361) and the second male part (32) includes outer threads (321) which are engaged with the inner threads (361).

8. The tool box as claimed in claim 7, wherein each of the second female parts (36) is received in a recess (114) defined in the outside of the too box (1) and the second male parts (32) are connected to the carry unit (2).

9. The tool box as claimed in claim 8, wherein the carry unit (2) is a single shoulder strap (23/27), a combination of a shoulder strap (20) and an adjustment strap (21), a combination of a shoulder strap (20), an adjustment strap (21) and a buckle (22), or a combination of a shoulder strap (20), an adjustment strap (21), a buckle (22) and a connection strap (25).

10. The tool box as claimed in claim 3, wherein carry unit (2) is a single shoulder strap (23/27) and the female part (35) of the securing unit (3) is connected to an end of the single shoulder strap (23/27), the female part (35) is connected to a male part (30) on the tool box (1).

11. The tool box as claimed in claim 3, wherein carry unit (2) includes a shoulder strap (20) and an adjustment strap (21) which is connected to the shoulder strap (20), each of two respective ends of the shoulder strap (20) and the adjustment strap (21) has the female part (35) connected thereto which is connected with the male part (30) on the tool box (1).

12. The tool box as claimed in claim 3, wherein carry unit (2) includes a shoulder strap (20), an adjustment strap (21) and a buckle (22), two respective ends of the shoulder strap (20) and the adjustment strap (21) are connected to each other by the buckle (22), each of the shoulder strap (20) and the adjustment strap (21) has the female part (35) connected thereto which is connected to the male part (30) on the tool box (1).

13. The tool box as claimed in claim 3, wherein carry unit (2) includes a shoulder strap (20), an adjustment strap (21), a buckle (22) and a connection strap (25), two respective ends of the shoulder strap (20) and the adjustment strap (21) are connected to the connection strap (25), and another two respective ends the shoulder strap (20) and the adjustment strap (21) are connected to each other by the buckle (22), each of the shoulder strap (20), the adjustment strap (21) and the connection strap (25) has the female part (35) connected thereto which is connected to the male part (30) on the tool box (1).

14. The tool box as claimed in claim 3, wherein carry unit (2) includes a shoulder strap (20), an adjustment strap (21), a buckle (22) and a connection strap (25), two respective ends of the shoulder strap (20) and the adjustment strap (21) are connected to the connection strap (25), and another two respective ends the shoulder strap (20) and the adjustment strap (21) are connected to each other by the buckle (22), each of the shoulder strap (20), the adjustment strap (21) and the connection strap (25) has the male part (30) connected thereto which is connected to the female part (35) on the tool box (1).
